(19) United States
(12) Patent Application Publication
(10) Pub. No.: US 2024/0130919 A1
(43) Pub. Date: Apr. 25, 2024

(54) SYSTEM FOR GAIT TRAINING

(71) Applicant: Board of Regents, The University of Texas System, Austin, TX (US)

(72) Inventors: James Sulzer, Austin, TX (US); John Zheng Yan Ching, Austin, TX (US); Dylan Cole, Austin, TX (US); Madison Gavin, Bee Cave, TX (US); Jonathan Tao, Pleasanton, CA (US)

(21) Appl. No.: 18/472,378

(22) Filed: Sep. 22, 2023

Related U.S. Application Data
(60) Provisional application No. 63/379,341, filed on Oct. 13, 2022.

(51) Int. Cl. A61H 3/00; A61H 3/04

(52) U.S. Cl. CPC A61H 3/008; A61H 3/04; A61H 2003/007; A61H 2201/0192; A61H 2201/1652

(57) ABSTRACT

A system for gait training is disclosed. The system includes a frame having a first, second, third and fourth leg. A pivoting bar is rotatably coupled to an upper portion of the frame and configured to rotate independent of the frame. A plurality of flexible support members are connected to the frame, the plurality of flexible support members including at least one upright flexible support member connected to the pivoting bar and at least one lateral flexible support member connected to at least one of the first, second, third and fourth legs.

### CROSS-REFERENCE TO RELATED APPLICATIONS

This application claims priority to U.S. provisional application No. 63/379,341 filed Oct. 13, 2022, incorporated herein by reference in its entirety.

### BACKGROUND OF THE INVENTION

Typically, gait trainers are used to rehabilitate non-ambulatory patients, or a person that is unable to walk but may be mobile with the help of mobility devices. Of the approximately 72,835,047 people under the age of 18 in the United States in 2019, the Census Bureau estimates that 0.5%, or about 329,766, of them have an ambulatory disability. Possible causes for ambulatory disabilities include cerebral palsy, traumatic brain injury, incomplete spinal cord injury, and multiple sclerosis.

These disabilities typically cause patients to have difficulty with the four main requirements for a gait cycle. The first requirement is being able to support the trunk or stabilize and balance the upper body. The second requirement is clearing the foot or being able to move one foot ahead of the other in preparation for the next step. The third requirement is propulsion, which enables the body to move itself forward. Propulsion does not indicate clearing the foot and vice versa. The fourth and last requirement is supporting bodyweight. (See e.g. Schafer RC. Chapter 4: Body Alignment, Posture, and Gait. In: Clinical Biomechanics Musculoskeletal Actions and Reactions. 2nd ed. Baltimore, Maryland: Williams & Wilkins; 1987). These requirements are typically quantified by their effect on the patient's stride length, step width, swing phase duration, stride times, and double support times (Cameron MH, Nilsagård YE. Maintaining ambulation. Practical Neurology. Published Feb. 2019).

Gait trainers are rehabilitation or mobility devices meant to help patients exercise their gait in isolation of supporting their own body weight and postural alignment or trunk support. One goal of these trainers is to free the patient of strain of weight aspects of their body weight while also relieving the fear of falling such that the patient can focus on refining other elements of their gait, such as coordinating clearing the foot, and begin to develop a more natural, ambulatory gait. Some gait trainers also use treadmills or even robotic gait assistance to aid in the formation of a repeated and consistent movement pattern to help patients relearn the movements of a gait cycle. (Ammann-Reiffer C, Bastiaenen CHG, Meyer-Heim AD, van Hedel HJA. Effectiveness of robot-assisted gait training in children with cerebral palsy: A bicenter, pragmatic, randomized, cross-over trial (pelogait). BMC Pediatrics. 2017;17(1). doi:10.1186/s12887-017-0815-y). This serves the dual purpose of aiding the rehabilitation of ambulatory gait and promoting normal joint movement to reduce joint pain. (Cameron MH, Nilsagård YE. Maintaining ambulation. Practical Neurology. Published Feb. 2019).

Due to the variability of patient needs, both initially and throughout the rehabilitation process, physical therapists tend to prefer gait trainers that can be tailored to their patients. In some aspects, the gait trainers best suited for physical therapy have simple construction and are adjustable. Because the gait rehabilitation process involves targeting specific movements or isolating specific muscle groups, having an adaptable system to accommodate a variety of purposes means the physician can use a single machine to perform many rehabilitative exercises. Conventional gait trainers tend to focus primarily on mobility or rehabilitation, but not both. The fundamental features of gait trainers that provide mobility tend to conflict with the features needed to assist with rehabilitation, and vice versa.

Accordingly, there is a need in the art for a gait trainer that can provide superior mobility and rehabilitation functionality. The system should provide partial body weight support while maintaining portability, remaining lightweight, and have the ability for safe, nimble and independent use by the patient throughout residential and public settings, all while facilitating mobility and rehabilitation.

### SUMMARY OF THE INVENTION

In one embodiment, a system for gait training comprises a frame comprising a first, second, third and fourth leg, a pivoting bar rotatably coupled to an upper portion of the frame and configured to rotate independent of the frame, and a plurality of flexible support members connected to the frame, the plurality of flexible support members comprising at least one upright flexible support member connected to the pivoting bar and at least one lateral flexible support member connected to at least one of the first, second, third and fourth legs. In one embodiment, the at least one upright flexible support member is one of a plurality of upright flexible support members connected to the pivoting bar. In one embodiment, the at least one lateral flexible support member is a first lateral flexible support member connected to the first leg, and wherein a second lateral flexible support member is connected to the second leg, a third lateral flexible support member is connected to the third leg, and a fourth lateral flexible support member is connected to the fourth leg. In one embodiment, the first, second, third and fourth lateral flexible support members are elastic. In one embodiment, the first, second, third and fourth lateral flexible support members are bungee straps. In one embodiment, the first, second, third and fourth lateral flexible support members are connected to a user harness. In one embodiment, the first, second, third and fourth lateral flexible support members are configured to the user harness at waist level and configured to provide steering support. In one embodiment, the plurality of upright flexible support members are connected to a user harness. In one embodiment, the plurality of upright flexible support members are configured to provide omnidirectional support to a user. In one embodiment, the at least one upright flexible support member is adjustable in at least one of length, direction and magnitude of force applied. In one embodiment, each leg comprises a caster mounted to a bottom portion. In one embodiment, the frame is configured to permit adjustment of width between adjacent legs while in use. In one embodiment, the frame is configured to bias towards an unadjusted state while in an adjusted state. In one embodiment, the frame is configured to increasingly bias towards an unadjusted state when moving increasingly into an adjusted state. In one embodiment, the frame comprises an upper arch comprising the first and third leg, and a lower arch comprising the second and fourth leg. In one embodiment, the upper arch and lower arch each comprise an opening that aligns for accepting insertion of a connection element that couples the upper arch and lower arch along a central axis. In one embodiment, the system further comprises a hinge having a shaft fixed within the lower arch of the frame, wherein the shaft comprises a mounting point along the central axis for the pivoting bar. In one embodiment, the hinge further comprises a hinge lock. In one embodiment, the hinge lock comprises of at least three linkages each connecting to different legs. In one embodiment, the frame is configured with a protrusion to block adjacent leg angles less than a predetermined number of degrees

### BRIEF DESCRIPTION OF THE DRAWINGS

The foregoing purposes and features, as well as other purposes and features, will become apparent with reference to the description and accompanying figures below, which are included to provide an understanding of the invention and constitute a part of the specification, in which like numerals represent like elements, and in which:

FIGS. 1A, 1B and 1C are alternate perspective views of a gait training system according to one embodiment, FIG. 1A without flexible supports attached, FIG. 1B with flexible supports attached, and FIG. 1C with flexible supports attached to a dummy body according to one embodiment.

FIGS. 2A and 2B are top and side views respectively of a gait training system according to one embodiment.

FIG. 3 shows a cross section (left) and exploded view (right) of hinge assembly connecting the upper arch to the lower arch of the frame according to one embodiment.

FIG. 4 shows a perspective partial view of a hinge lock assembly with three linkages according to one embodiment.

FIGS. 5A and 5B are top views of the hinge lock in first and second positions according to one embodiment.

FIGS. 6A, 6B and 6C are top view illustrations a gait training system moving through a narrow doorway according to one embodiment.

FIG. 7 is a perspective view of a caster wheel used on the gait training system according to one embodiment.

FIGS. 8A and 8B show the assembly level finite element analysis (FEA) results for normal use (left) and hitting an object (right) according to one embodiment.

FIG. 9 shows the FEA results for impact loading on the frame according to one embodiment.

FIG. 10 illustrates a frame steering force diagram of the system according to one embodiment.

FIG. 11 shows the testing performed to determine the force needed to move the system from rest according to one embodiment.

FIGS. 12A and 12B are diagrams illustrating the standing (left) and crawling (right) bounding box of the frame according to one embodiment.

FIGS. 13A and 13B shows the different modes of support on the patient as the bungee straps are transitioned from walking to crawling according to one embodiment.

FIG. 14 shows the exemplary assembled wheel shielding according to one embodiment.

FIG. 15 is the exemplary assembled frame shielding according to one embodiment.

FIG. 16 illustrates a bird's eye view of the accessible surrounding area of the system to a patient according to one embodiment.

FIG. 17 shows the collapsed system during assembly according to one embodiment.

FIG. 18 is a graph representing the dynamic tipping simulation results for an 8 lbs load according to one embodiment.

FIG. 19 is a photograph of the force to tip testing being performed on the system according to one embodiment.

FIG. 20 illustrates the slope tip testing of the system according to one embodiment.

FIG. 21 illustrates the average limb segment length as a function of height according to one embodiment.

FIG. 22 shows a dynamic tipping simulator flow chart according to one embodiment.

FIG. 23 is a graph illustrating the raw force versus displacement data for the bungee straps, or flexible support members according to one embodiment.

FIG. 24 is a graph illustrating the stress versus stretch data for the bungee straps, or flexible support members according to one embodiment.

FIG. 25 is a graph showing the displacement from preloaded height to full support for a 60 lb child according to one embodiment.

FIGS. 26A and 26B show magnified views of a frame pickup point design according to one embodiment.

FIG. 27 is a side view of a modified harness according to one embodiment.

FIG. 28 is a magnified view of a caster and wheel shielding according to one embodiment.

### DETAILED DESCRIPTION OF THE INVENTION

It is to be understood that the figures and descriptions of the present invention have been simplified to illustrate elements that are relevant for a clearer comprehension of the present invention, while eliminating, for the purpose of clarity, many other elements found in systems for partial weight support gait trainer for mobility and rehabilitation. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are described.

As used herein, each of the following terms has the meaning associated with it in this section.

The articles “a” and “an” are used herein to refer to one or to more than one (i.e., to at least one) of the grammatical object of the article. By way of example, “an element” means one element or more than one element.

“About” as used herein when referring to a measurable value such as an amount, a temporal duration, and the like, is meant to encompass variations of ±20%, ±10%, ±5%, ±1%, and ±0.1% from the specified value, as such variations are appropriate.

Ranges: throughout this disclosure, various aspects of the invention can be presented in a range format. It should be understood that the description in range format is merely for convenience and brevity and should not be construed as an inflexible limitation on the scope of the invention. Where appropriate, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

Referring now in detail to the drawings, in which like reference numerals indicate like parts or elements throughout the several views, in various embodiments, presented herein is a system for partial weight support gait trainer for mobility and rehabilitation.

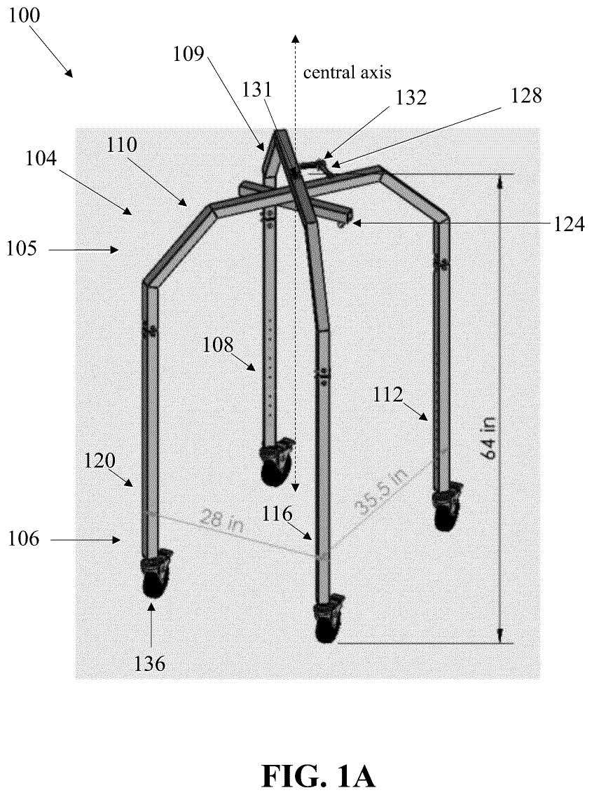

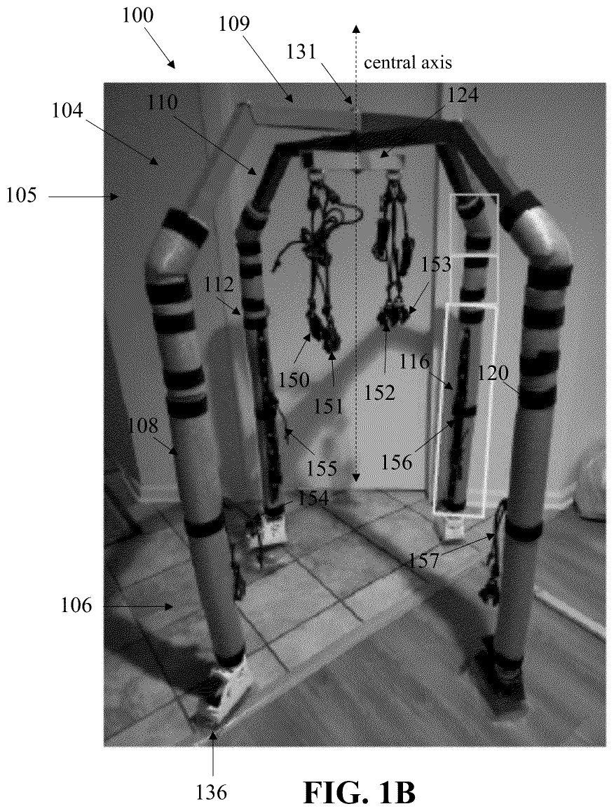

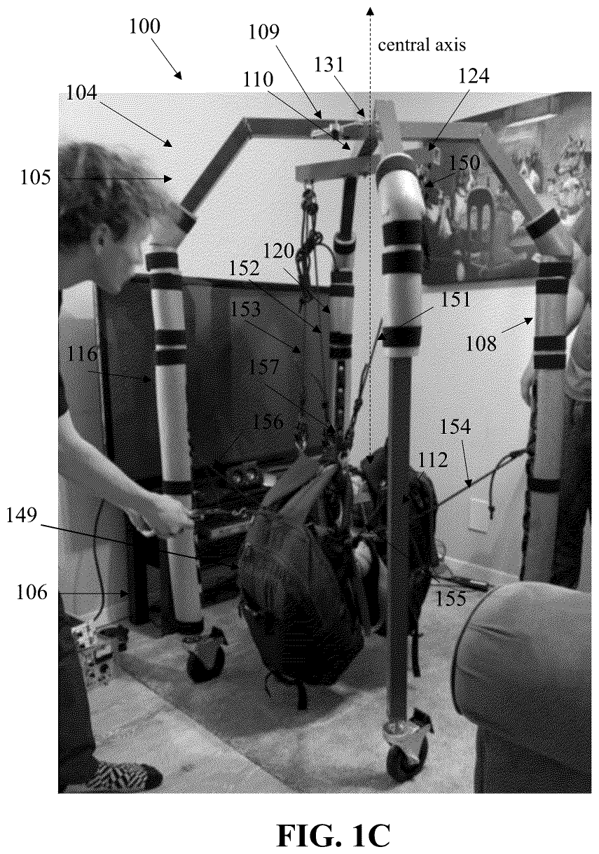

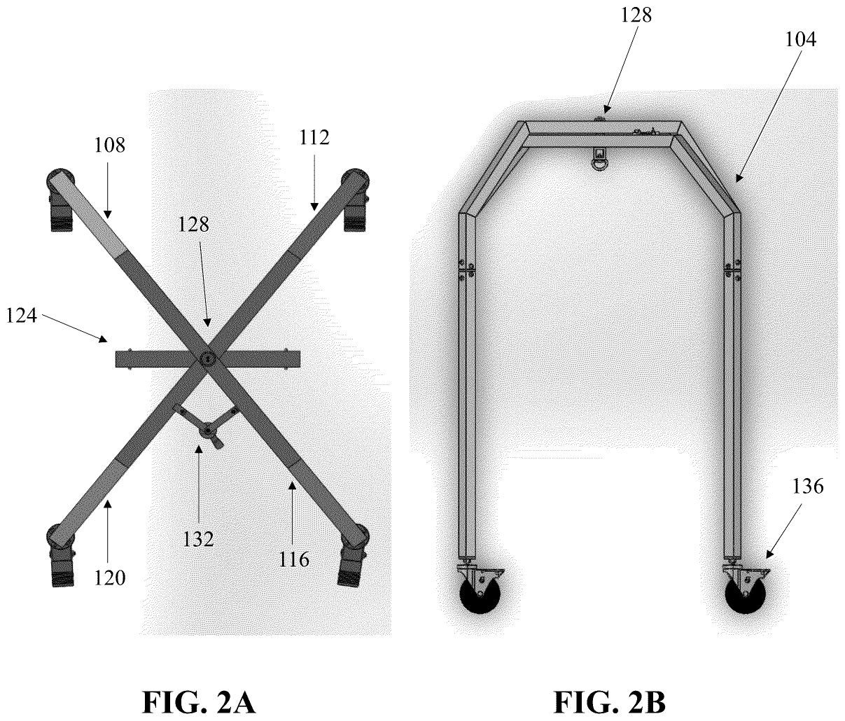

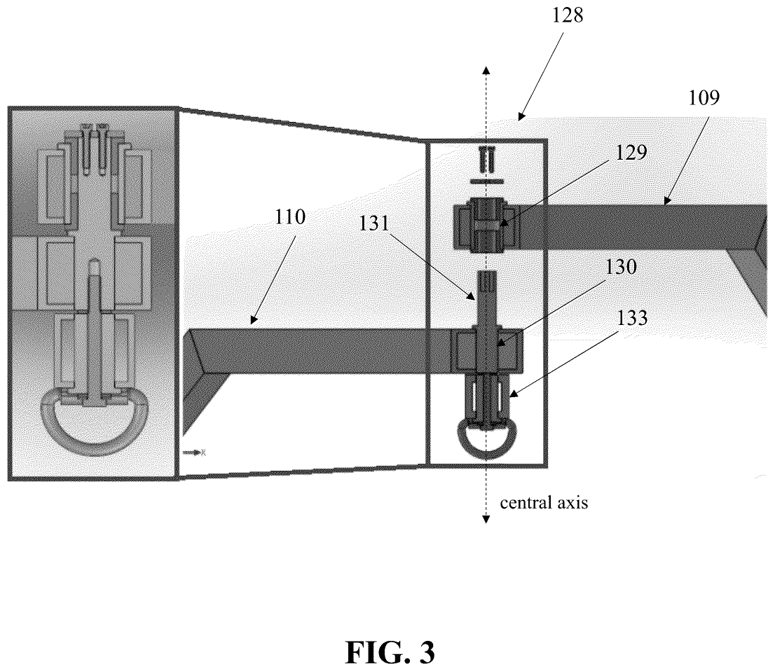

With reference now to FIGS. 1A through 2B, a gait training system 100 is shown according to one embodiment. The system 100 includes a frame 104 having a first leg 108, second leg 112, third leg 116 and fourth leg 120. The frame 104 has an upper portion 105 and a lower portion 106, and a pivoting bar 124 is rotatably coupled to the upper portion 105 of the frame 104 and configured to rotate independent of frame 104. The frame 104 can have an upper arch 109 that connects the first leg 108 and the third leg 116, and a lower arch 110 that connects the second leg 112 and the fourth leg 120. The upper arch 109 and lower arch 110 can each have an opening 129, 130 (and see e.g. magnified view of FIG. 3) that aligns for accepting insertion of a connection element 131 such as a bolt that couples the upper arch 109 and lower arch 110 along a central axis. This connection allows the frame 104 to adjust its width between adjacent legs, allowing for narrowing the frame 104 while in use.

With reference specifically to FIG. 1B, flexible support members are connected to frame 104. Flexible support members include upright flexible support members 150, 151, 152, 153, connected to the pivoting bar 124 and lateral flexible support members 154, 155, 156, 157 connected to each of the legs 108, 112, 116, 120. The upright flexible support members 150, 151, 152, 153 provide upright support to the patient, and since they're connected to the pivoting bar 124, they allow the patent a certain degree of rotational movement independent of whether the frame 104 is moving or stationary. The lateral flexible support members 154, 155, 156, 157 are connected to each of the legs 108, 112, 116, 120 and provide lateral support to the patient. The flexible support members can for example connect to a harness having multiple connection points as explained further below.

With reference to FIG. 1C, when the support members are connected to the patient (represented here by a dummy patient or weighted bags 149), they can be selected and sized such that tension on each of the upright flexible support members 150, 151, 152, 153 is substantially equal, and tension on each of the lateral flexible support members 154, 155, 156, 157 is substantially equal. This way, the frame 104 will naturally bias in an unadjusted state to have substantially equal distance between each leg, maintaining a substantially square footprint. Advantageously, since the support members can be elastic, the frame can increasingly back bias towards an unadjusted state when moving into a narrowed or adjusted state as increasing tension on the support members due to elongate will tend to pull the frame back to its resting state. This is particularly helpful when for example moving the frame 104 though a narrow space, allowing the patient to temporarily narrow the frame. When the frame 104 is narrowed, it will bias back toward the square and more stable footprint of the unadjusted state. Additional elastic members can be connected between the legs to further bias the legs back towards a starting/resting position depending on patent needs and the physical environment.

In one embodiment, the system 100 includes a plurality of flexible support members connected to pivoting bar 124. The plurality of flexible support members comprising at least two upright flexible support members 1100 connected to pivoting bar 124. The plurality of upright flexible support members 1100 are configured to provide omnidirectional pivot bar support to a user and are adjustable in at least one of length, direction and magnitude of force applied. Furthermore, the plurality of upright flexible support members 1100 are connected to a user harness.

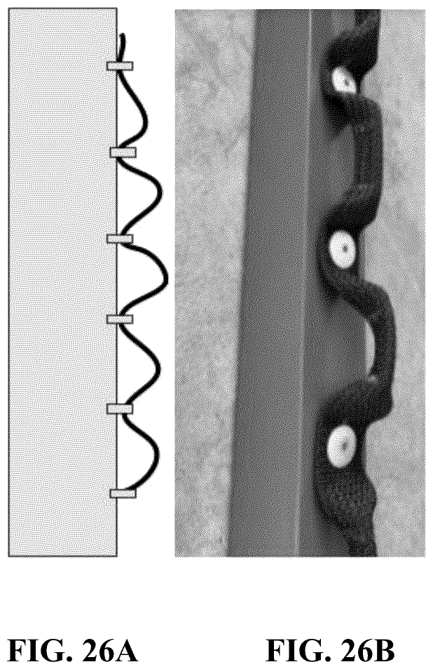

In one embodiment, the plurality of flexible support members also includes at least one lateral flexible support member connected to at least one of the first leg 108, second leg 112, third leg 116 and fourth leg 120. In an embodiment, at least one lateral flexible support member is a first lateral flexible support member connected to the first leg 108, and wherein a second lateral flexible support member is connected to the second leg 112, a third lateral flexible support member is connected to the third leg 116, and a fourth lateral flexible support member is connected to the fourth leg 120. The first, second, third and fourth lateral flexible support members may be elastic and adjustable. The first, second, third and fourth lateral flexible support members may be bungee straps. The first, second, third and fourth lateral flexible support members are connected to a user harness and may be configured to the user harness at waist level and configured to provide steering support. Furthermore, in another embodiment, lateral flexible support members may possess adjustability along the first leg 108, second leg 112, third leg 116 and fourth leg 120 as shown in FIG. 26 and described below.

Embodiments of system 100 described herein have an emphasis on maximizing the user's access to their surroundings via minimizing device components around and near the patient. Embodiments of the system 100 feature adjustable overhead body weight support from frame 104 and configurable steering straps, or plurality of flexible support members, attached at the user's hips via a harness or suit of the sort. Additional features include frame width adjustability via a hinge that connects frame legs and a pivoting bar 124 on which the upright flexible support members connect to allow for omnidirectional movement with minimal resistance. Additionally, the number of legs is four, as a four-legged system 100 is more resistant to tipping under load than a device with only two or three legs, which can be a critical safety concern. Embodiments of the system 100 can easily navigate and move with a residential setting and are adjustable to fit through door frames, traverse flooring transitions, and stay below the required height clearance.

With reference now to FIG. 3, in one embodiment, the system 100 includes a hinge 128 having a opening 130 within the lower arch 110 of the frame 104, and a mounting point 133 along the central axis for the pivoting bar 124. The frame 104 or may also include one or more protrusions 135 which in certain embodiments can be built into the hinge 128 to block adjacent leg angles less than a predetermined number of degrees. The most stable position for frame legs to be in is equidistant from each other, joining at the top at a 90-degree angle. However, in order for system 100 to stable under the loading specified, the frame 104's base needed to be wider than the width of a doorway. As such, a hinge 128 can be implemented at the intersection of the legs to allow the width of system 100 to partially collapse when navigating doorways and hallways while also allowing the option of the more stable configuration.

The hinge, as shown in FIG. 3, consists of a shaft fixed within the lower arch of frame 104 that is inserted into bushings in an insert in the upper arch of frame 104 and it is between these two surfaces that hinge 128 rotates. The lower arch's shaft insert also serves as the mounting point for pivoting bar 124 on which the overhead, lateral support bungees/members 1104 are attached. In an embodiment, at the top of the hinge, two screws and a washer hold hinge 128 in place and provide a slight amount of preload. Two screws were used rather than one to prevent the screws from loosening during the rotating motion of the assembly.

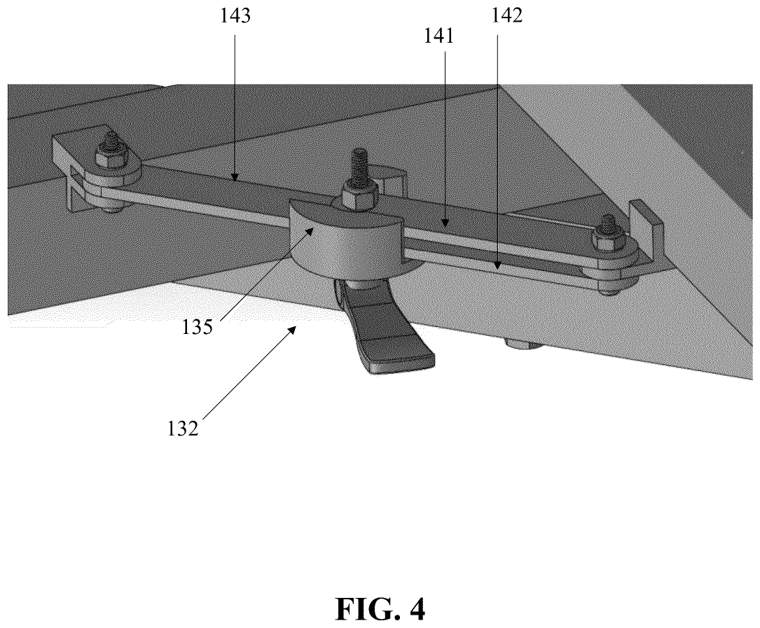

In an embodiment and in order to ensure that the hinge 128 does not collapse more than the required 75 degrees needed to reduce the width of system 100 to 28 inches, a locking mechanism may be added to frame 104. Locking mechanism may be a hinge lock 132 as illustrated in FIG. 4. This is because any additional collapsing of frame 104 makes system 100 more susceptible to tipping and general instability.

In one embodiment, the hinge lock 132 consists of three linkages 141, 142, 143, two connecting to one leg 141, 142 and one connecting to the other 143. Three linkages were chosen in order to place bolts connecting them in double shear rather than single shear. These linkages meet in the middle and are pressed together by a CAM lock that prevents the movement of the legs relative to each other by locking the hinge 128 via friction. The movement of these linkages are further restricted by the inclusion of a hard stop 135, which acts as a physical barrier preventing the linkages from moving beyond a 75 or 90-degree angle.

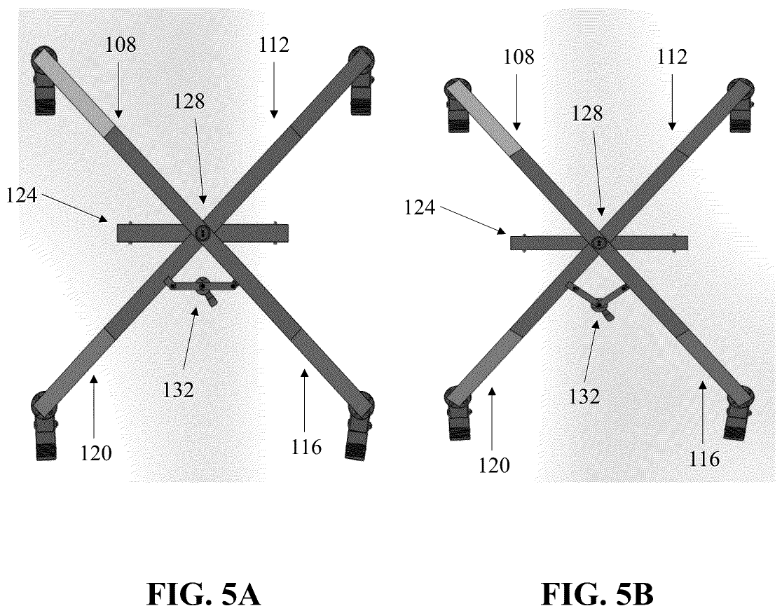

Now referring to FIG. 5, in one embodiment, the hinge lock 132 may be locked in various positions or angles depending on the three linkages comprising the hinge lock 132.

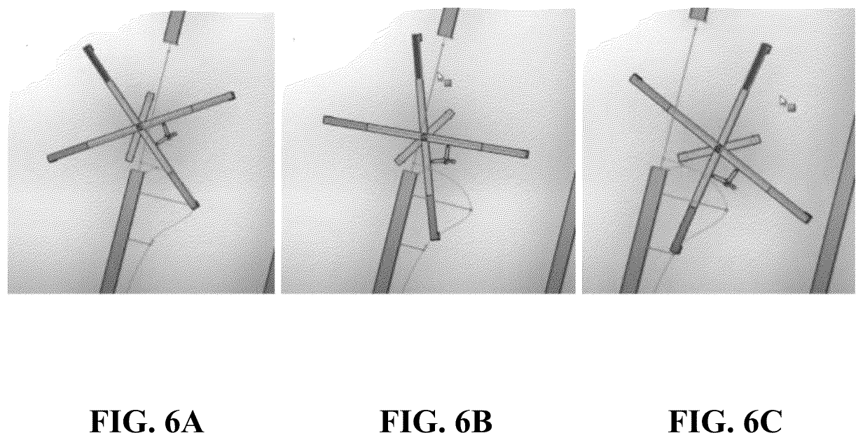

To verify that system 100 can navigate a residence such as a doorway or the ones referred to above, system 100's assembly was placed inside of a SolidWorks CAD model of a typical residential hallway that includes a turn and doorframes with the minimum width set by the engineering specifications. As shown in FIG. 6, system 100 was able to navigate the simulated hallway successfully.

### Caster Wheels

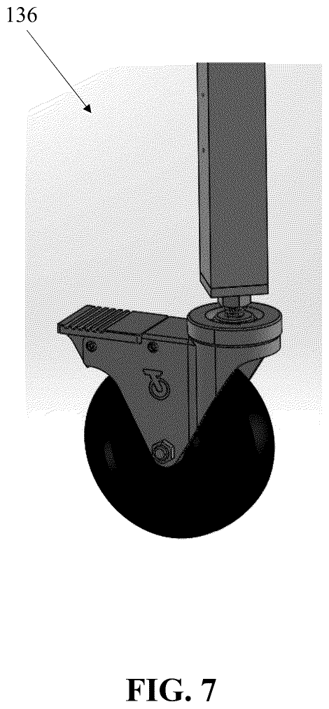

Each leg of frame 104 may comprise a caster wheel 136 mounted to a bottom portion of the leg, as shown in FIG. 7 according to one embodiment. An important factor in choosing a wheel that must overcome obstructions is the wheel radius. A wheel rolling over an obstruction of significant size has an induced resistance, which can be calculated with the formula:

$${F}_{H} = Mg \frac{\sqrt{2 R H - {H}^{2}}}{R - H} \qquad Equation 1$$

where M is the mass of system 100 in kg, g is the gravitational constant (9.81 m/s²), R is the radius of the wheel in meters, and H is the height of the obstruction in meters.

Because the wheels must be able to traverse an obstruction at least ¾″ tall, the design team can compare the horizontal resistance forces from varying wheel radii. Table 1 below summarizes the comparisons between wheel sizes 4-6″ based on the estimated system mass of 8.75 lbs. per leg.

TABLE 1
Wheel Diameter and Force to Traverse 0.75″ Transition

| Wheel Diameter (in) | Horizontal Resistance Force (lbf) |
|---|---|
| 4″ | 10.93 |
| 5″ | 8.93 |
| 6″ | 7.72 |

These calculations show that the larger the radius of the wheel, the less force is required to traverse obstacles like flooring transitions. This requirement in addition to other factors for caster selection were considered when selecting the casters 136 used on the invention described herein.

### Safely Provide Support

The gait trainer system described herein shall be able to support 60 lbs with a safety factor larger than 3. This specification was incorporated into the design process through material selection and was verified via Finite Element Analysis (FEA) on SolidWorks, further explained below.

### Material Selection Summary

In an embodiment, to keep frame 104 as light as possible, system 100 maybe comprised of aluminum, which is less dense than steel and cheaper than titanium. Welding between parts of system 100 was selected over fasteners to increase sturdiness. To reduce the complexity of manufacturing, the team decided against bending tubes.

The common grades of aluminum available for square tubing are 6061 and 6063, both of which weaken when welded, and due to time and financial constraints, it was decided not to heat treat frame 104 after welding. The as welded yield strength values were taken from the ASM handbook, and the whole all welded members were assumed to have the weakened yield strength for simulation.

### Overall FEA Results: Typical Loading Case

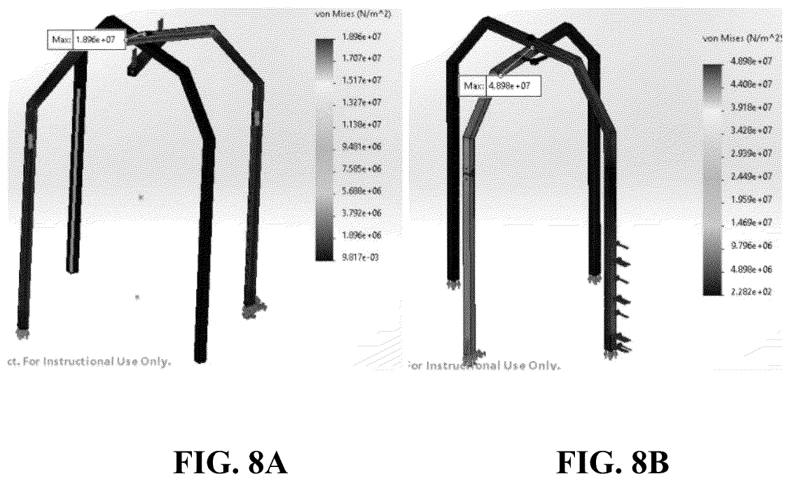

The first FEA result was for the worst-case scenario during normal use, where only two legs are supporting the max weight of a child, 60 lbs, applied at pivoting bar 124. As shown in FIG. 8, the gait trainer achieved a safety factor of 7.3. The gait trainer was also tested for cases of bumping into objects, with an estimated maximum force of 30 lbs applied on one of the legs, and the safety factor was 2.9, also shown in FIG. 8.

### Overall FEA Results: Impact Loading Case

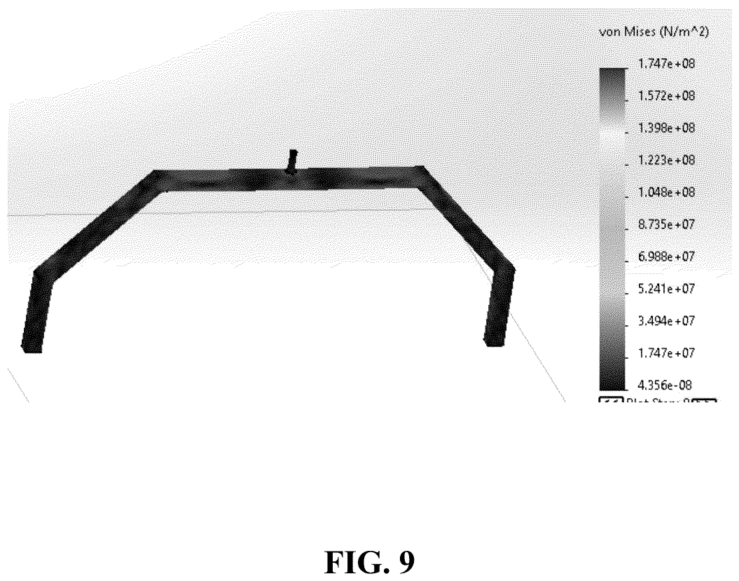

In an embodiment, the gait trainer is designed to be disassembled and carried in the trunk of a sedan, thus there is a risk of dropping a subassembly. A drop test simulation was conducted on the heaviest disassembled part on Solidworks to ensure that the pieces will not break if dropped. FIG. 9 shows the stresses experienced by frame 104 after a 3-foot drop, which are lower than the ultimate tensile strength of frame 104. However, the experienced stress was higher than the yield strength, so some minor, localized bending or deformation may occur.

### Weight Reduction

System 100 described herein must be operable by the patient. In the case of the gait trainer, patient operation includes the propulsion and steering of system 100. To reduce the force required to propel system 100, efforts were made to reduce system 100's weight. The most significant weight saving decision was the selection of frame tube materials and sizing. 6061 aluminum was chosen over similarly dense 6063 aluminum because its yield strength is 29% greater, permitting the use of ⅛″ thick 6061 frame tubing instead of ¼″ thick 6063 (Dickerson PB. Welding of Aluminum Alloys. Olson DLR, Siewert TA, Liu S, Edwards GR, eds. Welding, brazing, and soldering. 1993;6. doi:10.31399/asm.hb.v06.9781627081733). This material choice reduced frame 104 weight to 35 lbs, 45% less than a frame constructed from 6063 aluminum.

### Hip Bungees and Bungee Configuration

In addition to being light enough to be propelled by the patient, system 100 must also adequately translate the patient's rotational and translational motion to frame 104: permitting system 100 to be steered by the patient. Although system 100's top support members succeed in supporting the patient's vertical body weight, they may not adequately translate lateral and rotational motion to frame 104 due to the bungee/member angle and freely pivoting bungee bar. Therefore, additional features may be developed to achieve the desired responsiveness.

Because there is vast diversity in capabilities and deficiencies among traumatic brain injury (TBI) patients, the gait trainer is designed to respond to the patients every move rather than require additional patient input. Additional input methods, such as handles for the patient to push system 100, can help some users maneuver system 100 more easily, but necessitating upper body engagement alienates patients unable to grip with their hands or apply force using their arms. For this reason, frame 104 may be coupled to the harness, connecting the patient to system 100 using lateral flexible support members 1104 (horizontal bungees) at hip height.

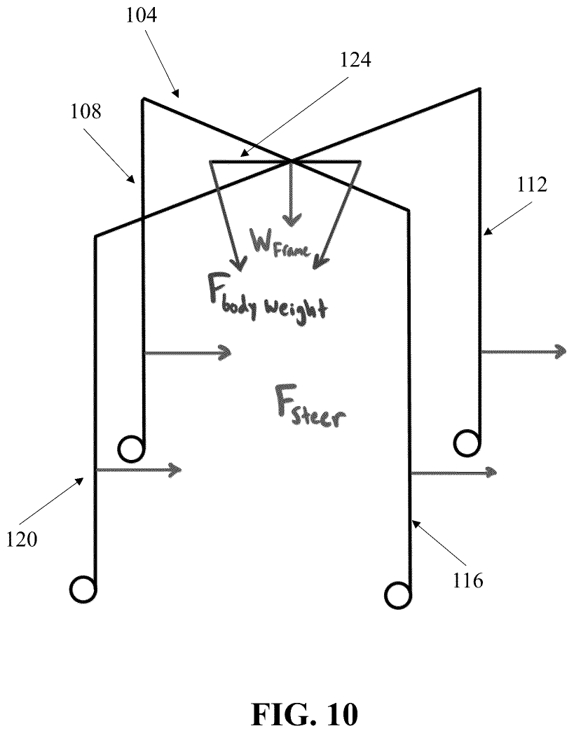

Now referring to FIG. 10, the force diagram illustrates that the bungees have frame pickup points at discrete heights to accommodate users of varying sizes and feature the same tensile adjustability as the top bungees, permitting system 100's translational and rotational response to be easily tuned. These optional steering bungees may permit the user to maneuver system 100 easily without requiring additional patient input.

### How Much Force to Pull

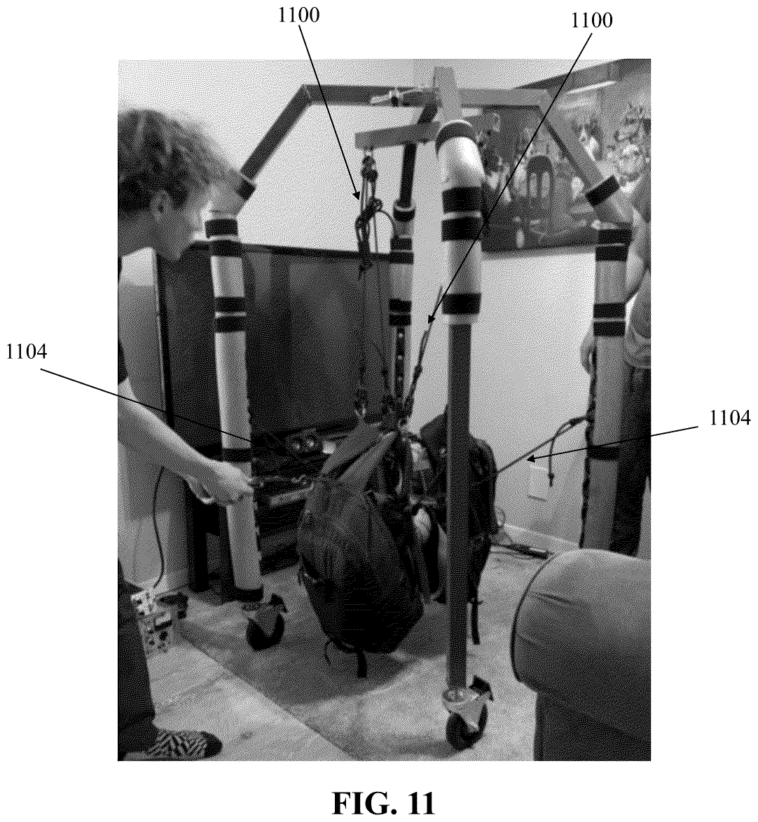

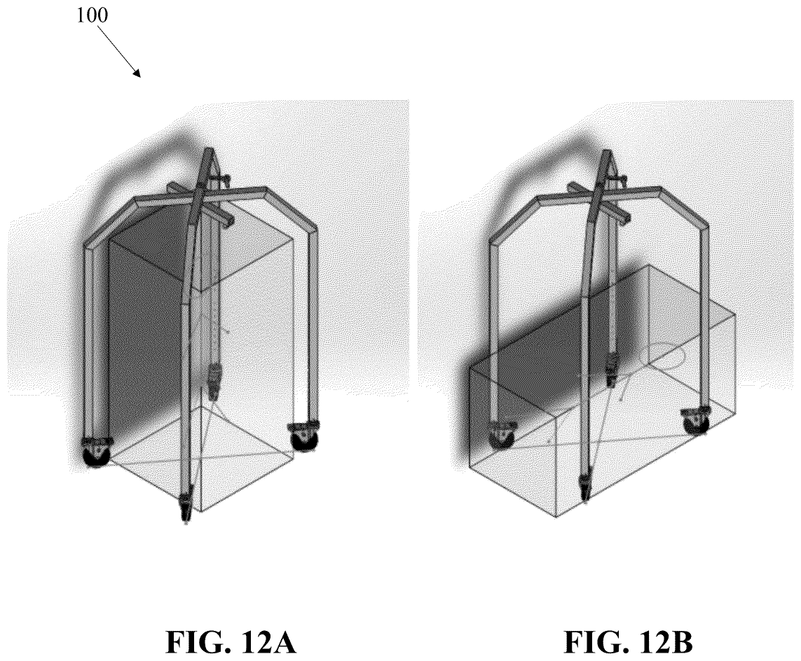

To verify that system 100 meets the requirements set forth, testing was performed to determine the amount of propulsion force needed to move system 100, as shown in FIG. 11. The testing showed that the user can operate system 100 with less than the required max propulsion force of 8 lbs. Results are reported in the section below.

### Bounding Box

As shown in FIG. 12, system 100 may also accommodate patients when they are crawling, kneeling, or walking. By facilitating each of these modes, system 100 achieves a greater potential for rehabilitation and provides mobility for methods of movement beyond just walking. To determine the area that must remain accessible, a patient was observed moving in each position, and the extreme positions of their movements were recorded. These extreme positions were used to determine the furthest a patient may reach in a given direction during their movement, and a bounding box was generated to comfortably accommodate this movement. The bounding box was then scaled up appropriately, using an anthropometric figure shown in FIG. 12, to the size of the largest child system 100 can accommodate: 49″.

### Different Modes of Support

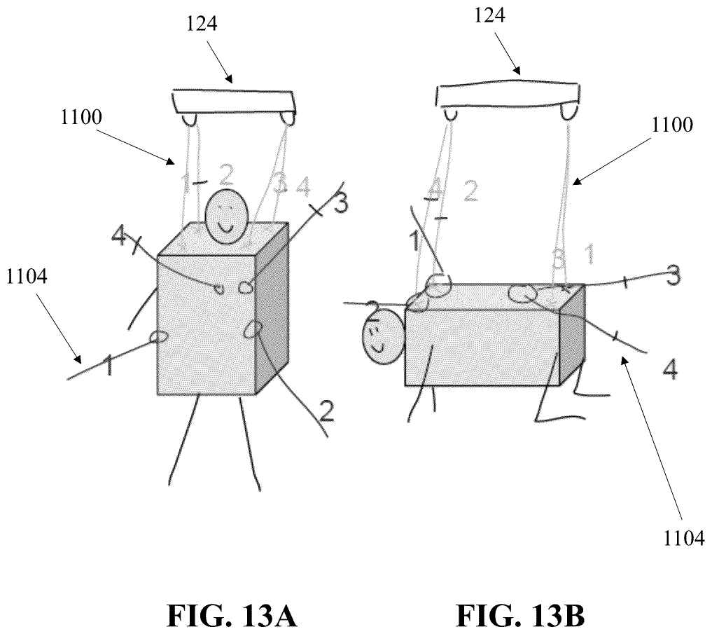

The design for system 100 herein may not only allows for the patient to be transitioned from a walking to crawling position, and vice versa, it also does so by only requiring four members to be removed and reattached, the hip support straps 1104 (shown through 1 and 2) and the upright support straps 1100 (shown through 1 and 3) as shown in FIG. 13. This makes the transitioning process between modes of support quicker and easier for the therapist or guardian to adjust and also makes it safer for the patient because they can be supported throughout the adjustment process. Upright flexible support members 1100 are shown above the user while lateral flexible support 1104 members shown beside them.

### Wheel Shielding

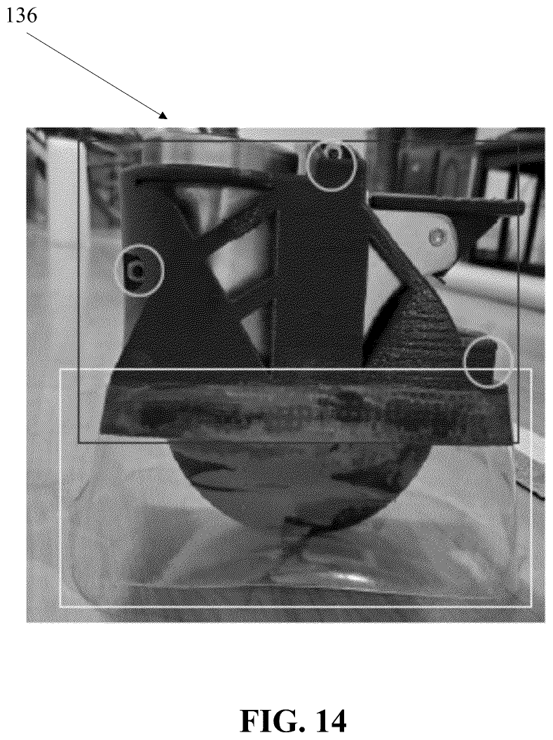

In an embodiment, the caster wheels 136 may include a wheel shielding device as shown in FIG. 14. The wheel shielding device design consists of two components: the mounting cover and a skirt made from a compliant material. The 3D-printed PLA mounting shield covers potential pinch points in the front and back of the wheel without impeding existing functionality. The vinyl skirt provides minor resistance to appendages while also deforming over ¾″ flooring transitions. FIG. 14 shows an exemplary wheel shielding design, with the bracket boxed above, the skirting material boxed below, and the fastener hardware circled.

### Frame Shielding

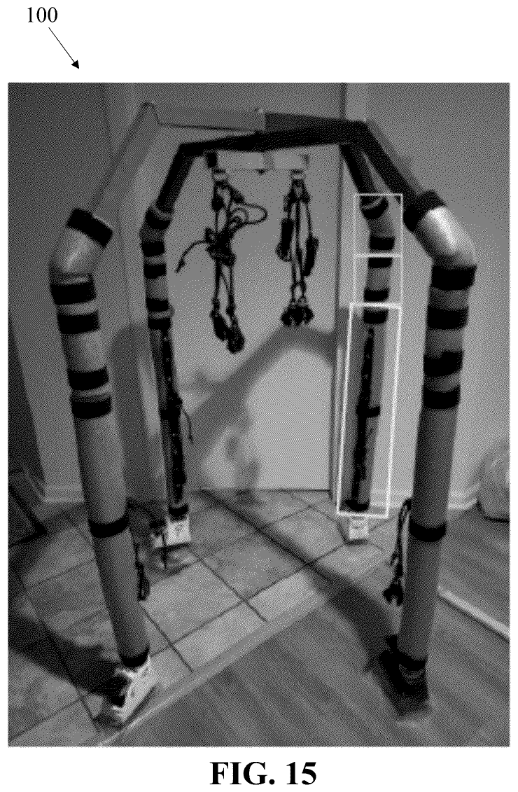

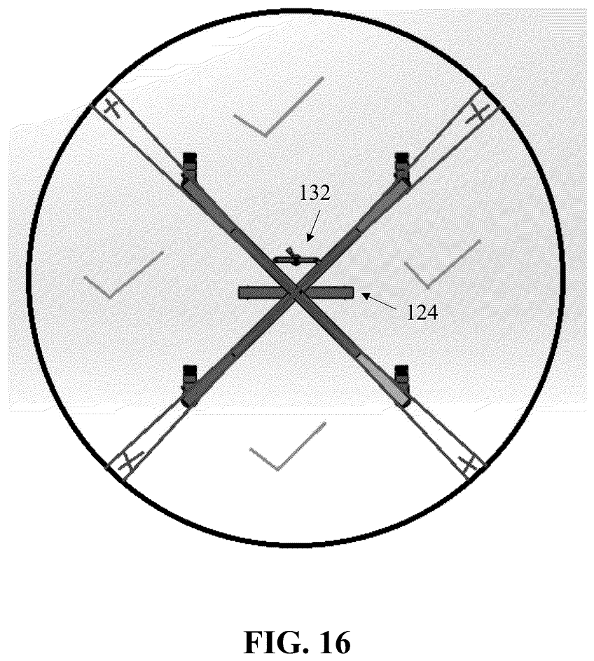

Now referring to FIG. 15, exemplary frame shielding is presented. To prevent injuries such as cuts, bruises, and abrasions that occur from contact with protruding hardware and exposed frame tubing edges, a frame padding device is necessary to reduce any unintended impacts. In an embodiment, frame 104 shielding consists of 3 sections of foam tubing per leg with a thickness of ⅜″ that cover each leg of frame 104 up to a height of 53 inches from the floor. Polyethylene foam cylinders, or pool noodles, may be chosen as the material because of its deformability, easy sourcing from local suppliers, and lowest cost. Each section of foam tubing may be secured with a minimum of two removable velcro straps to properly conform the padding to frame 104, with only the middle leg section, indicated below in a blue box, intended to be removed during normal disassembly of frame 104.

### Frame Tubes' Orientation and Geometry

With system 100 described herein, 80% of the patient's surrounding area be unobstructed to allow for interaction with other children and toys, as seen in FIG. 16. To satisfy this requirement, frame 104 was designed to occupy as little space as possible beneath the patient's head. Just four 1.5″×1.5″ vertical tubes separate the child and their surroundings. Rather than a more obstructive design that uses gussets for support, the simple, straight legged design minimizes interference with the patient's reach. Additionally, the hinge mechanism 128 allows for frame 104 legs to adjust in positioning. So, by opening up system 100 to a wider angle, a greater space can be reached in one direction, lateral or longitudinal, in exchange for reduced accessibility in the other direction.

### EXPERIMENTAL EXAMPLES

The invention is now described with reference to the following Examples. These Examples are provided for the purpose of illustration only and the invention should in no way be construed as being limited to these Examples, but rather should be construed to encompass any and all variations which become evident as a result of the teaching provided herein.

Without further description, it is believed that one of ordinary skill in the art can, using the preceding description and the following illustrative examples, make and utilize the present invention and practice the claimed methods. The following working examples, therefore, specifically point out the preferred embodiments of the present invention, and are not to be construed as limiting in any way the remainder of the disclosure frame, with only the middle leg section, indicated below in a blue box, intended to be removed during normal disassembly of frame 104.

### Test Results: How Much Force to Pull

The force required to move was the most important metric for the user, and the team tested it by loading the harness to the maximum weight it can handle, 60 lbs, and using a force gauge to pull it on hard floor and carpet. Multiple readings were taken, and the average was recorded as 2.7 lbs force to move on hard floor while it took 7.5 lbs force to move on carpet.

The force required to move when the casters 136 were locked was important for safety reasons, as the gait trainer shall not move easily when locked. The gait trainer was tested both at maximum load and unloaded, with the wheels locked on carpet and on hard floor. Multiple readings were taken, and the averages were recorded as 6.4 lbs on hard floor and 13.6 lbs on carpet for 0 lb weight on the gait trainer and 14.5 lbs on hard floor and 25.1 lbs on a carpet for 60 lbs weight on the gait trainer.

### Leg Collapsibility

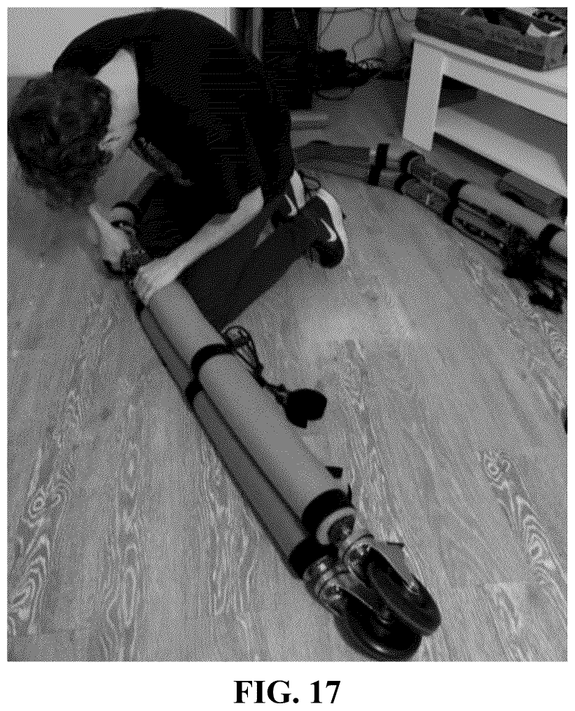

In an embodiment, system 100 for gait training may be quick and easy to collapse and have a collapsed size small enough to fit into an average sedan that can be seen in FIG. 17. This desired feature allows for easy transportation between locations as well as low footprint storage when not in use. Additionally, system 100 components shall be lightweight so that they can be moved easily. To achieve this goal, frame 104 was split into five assemblies: the upper assembly and four leg assemblies. This feature allows system 100 to be split into five compact, lightweight components and only requires one tool and eight ¼″-20 bolts to assemble and disassemble. Additionally, one 6-32 screw can be removed from the hinge lock 132 to collapse the upper assembly further. This operation may require two additional tools.

### Hinge Disassembly

In another embodiment, though simply removing the leg assemblies from system 100 is enough to lower the overall footprint to the required size, by removing two additional 6-32 bolts located at hinge lock 132, system 100 can be reduced to even smaller assemblies. This operation requires no new tooling and separates the upper frame assembly into two smaller assembly, allowing for easier transport as well as easier system repair if needed.

### Testing: Time it Takes to Collapse

Assembly and disassembly time was important, as the gait trainer was designed to be able to be transported. The gait trainer was assembled and disassembled, and the time taken was recorded.

To collapse system 100 to the specified size, one shall first remove the middle sections of each leg's foam shielding. Then, tip system 100 onto one of its sides. Then, using a ⅜″ wrench or ratchet, one must remove both ¼″-20 bolts from a lower leg's interface with the coupling plug and pull firmly to separate the assembly. Repeat for the remaining three legs. Then, one must use a 7/64″ hex key and an adjustable spanner to remove the 6-32 screw and lock nut from the hinge lock mounting point. The upper assembly can then be fully collapsed and stored with the leg assemblies. If a smaller footprint is required, disassemble system 100 further by removing the two 6-32 screws at the top of the hinge mechanism 128, again using the 7/64″ hex key, and pull apart the two pieces of the upper assembly. This process may take 6 minutes, as found through testing in FIG. 17.

To assemble system 100, slide the top part of the upper frame assembly onto the pivot of the bottom part of the upper frame assembly, place the two-holed washer on top of the hinge, and thread in both 6-32 screws. Then, connect the hinge lock to frame 104 using the 6-32 screw, 6-32 lock nut, and two accompanying washers. Once the hinge lock 132 is assembled, firmly insert each leg assembly into the respectively colored portion of the upper frame assembly, ensuring the nylon webbing faces the inside of system 100. Then, insert and torque two ¼″-20 bolts into each leg assembly. Flip system 100 back onto its wheels, check for assembly error, reattach the foam shielding, and proceed to use it. This process may take 9 minutes and 45 seconds, as found through testing.

### Simulated Weight Testing

Simulated weight training was done by placing weights in the harness to simulate the gait trainer's behavior when loaded and to prevent unexpected outcomes when testing with a person. The testing showed that the gait trainer behaved as expected, and the bungees were still in the elastic region at maximum load.

### Human Testing

Testing with a person using system 100 is required as a last step to ensure that system 100 is safe to use and that the end user is satisfied. This includes testing safety features as well as the general behavior of the gait trainer.

### Tipping Simulation Results Summary

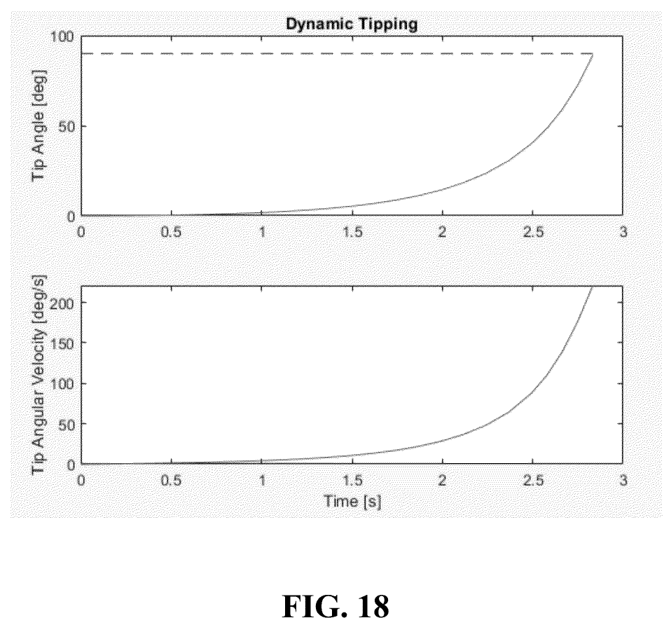

Referring now to FIG. 18, system 100 described herein must also be resistant to tipping and immobile when the wheels are locked. To ensure system 100's stability, a dynamic tipping simulator was written in MATLAB to determine the effect a horizontal load applied to the top of frame 104 has on system 100. This program uses a rigid model of frame 104 and geometrically derived moment arms to produce moments from the applied force, weight of frame 104, and patient body weight support. This dynamic simulation is necessary because static evaluation underestimates system 100's stability when the top of frame 104 is bumped, as the static evaluation simply performs a moment balance resulting in zero normal force on the outside legs, irrespective of the time for which the load is applied. Impulse loading can be evaluated with the dynamic simulation's output: figures graphing tip angle and tip velocity against time for a given set of loads, frame parameters, and initial conditions. Using the simulator, frame leg positions were determined such that system 100 will not tip from brief, less than 1.5 seconds, loading under 10 lbs nor under continuous loading of 7 lbs, even during the worst-case scenario of zero body weight support and in its narrowest state at the hinge.

### Force to Tip Testing

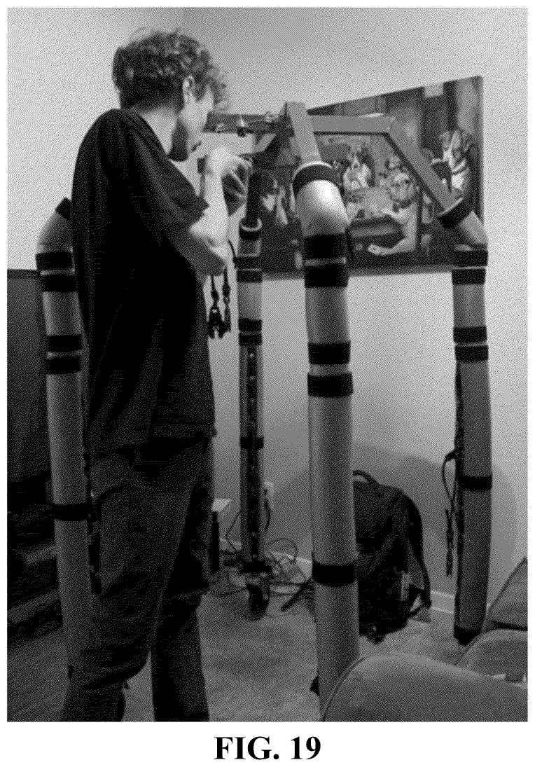

To verify the loading required to tip system 100 and as shown in FIG. 19, the gait trainer's wheels were locked, and a force gauge was pulled to apply a load to the top of system 100. The load was increased until two wheels lifted, and the measured load was recorded. For the worst-case scenario of all wheels locked, on carpet, zero bodyweight, and collapsed to the narrowest size hinge lock 132 allows, the continuous force required to lift two wheels was 7.2 lbs. When testing on hard floors, the unloaded system slides before tipping but not far before the expected load to tip. A horizontal load of 6.4 lbs is required to slide system 100 on laminate flooring, and system 100 will tip before sliding on carpet, even when the horizontal load is applied at the highest position of hip straps.

It was important to test the force and angle to tip, as system 100 had to be stable when in use. For the force to tip, the gait trainer was tested both fully loaded and empty, on both hard floor and carpet, in open and closed configuration, and the load was applied at the top of frame 104 with the wheels locked. Multiple readings were recorded with the force gauge for each scenario, and the average was recorded in the table 2 below. For the angle to tip, the gait trainer was placed on a piece of sheet metal, and the angle between the sheet metal and ground was increased incrementally until a desired angle was reached. The testing showed that frame 104 did not tip at 10 degrees.

TABLE II
Force Required to Tip

| | Force to move on | | Force to move | |
|---|---|---|---|---|
| Weight on Gait | Hard Floor (lbs) | | on carpet (lbs) | |
| Trainer (lbs) | 75 degrees | 90 degrees | 75 degrees | 90 degrees |
| 0 | slip | slip | 7.2 | 7.9 |
| 60 | slip | slip | 15.8 | 17.2 |

### Slope Testing

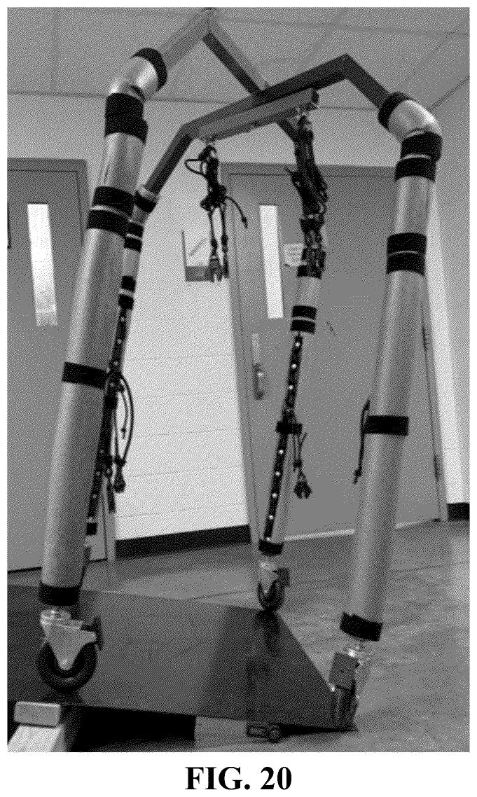

To ensure system 100 will not tip if at a slight angle due to flooring transitions, testing was performed as shown in FIG. 20. System 100 was placed on an angled piece of sheet metal, propped up by scrap wood. The angle of the sheet metal was changed until system 100 lifted its two upper wheels. This tipping occurred at an angle of approximately 18°, satisfying the 10°-degree requirement.

### Biometric Based Geometry

In order to ensure system 100 can accommodates the target user, Center for Disease Control data was used to translate the max weight of the harness (60 lbs) to an expected child height and age. The CDC charts allowed for the determination that 49 inches is the maximum child height system 100 can accommodate.

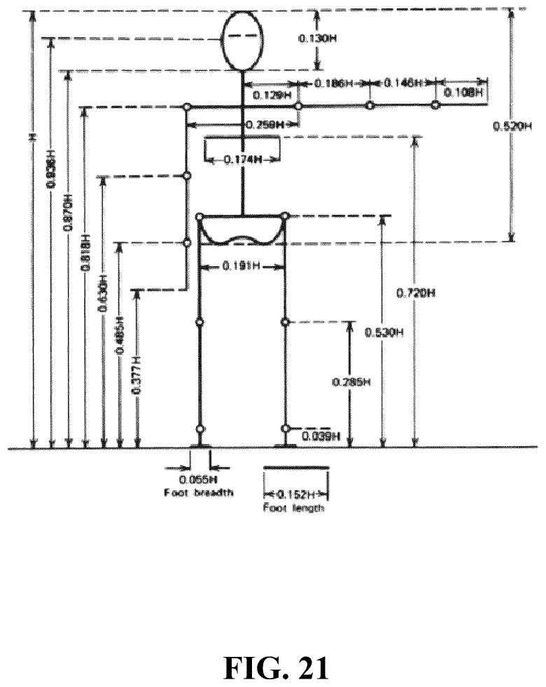

49 inches was chosen as the maximum child height because it coincides with the 50th percentile height to weight for 60 lbs. Once the maximum child height was determined, the bounding box generated by a patient's observed motion was scaled to that of the largest child. This process was performed by scaling the limbs of the patient using the following anthropometric data in FIG. 21 for average limb segment length by height.

The resulting, scaled bounding box used herein throughout was then used to determine basic frame geometry. Quantifying the user's range of motion allows for the ability to design frame 104 around the patient's movement. This ensures that the patient is not unnecessarily restricted by system 100, and that they can easily interact with other children and toys when in the gait trainer.

### Static Tipping Analysis

The first step taken in making sure system 100 will not tip during operation was a static moment balance taken about the point of wheel contact with the ground. This simple static evaluation was helpful in determining the sustained load required to tip system 100 over.

To evaluate the worst-case scenario for tipping, the applied load was made horizontal, and the downward force was set to the weight of frame 104 (no bodyweight support). For the first iterations of frame 104 design, a load of just 7 lbs causes frame 104 to tip. To increase the stability of system 100, the base was widened. A key issue with this static approximation is that it is only useful for evaluating continuous loading. Impulse loading due to frame 104 bumping objects is an expected loading case not properly evaluated by the static model. To account for impulse loads, a new method of evaluation was developed to determine the dynamic system response to non-continuous loading.

### Dynamic Tipping Analysis

The dynamic tipping simulator was developed in MATLAB and allowed for improvements not included in the static case: response to loading over time, vector loading, and initial condition input. The framework for the simulator uses a similar free body diagram to the static loading case, but the simulation takes forces as vectors, not scalars, and it uses the cross product between the force vectors and their geometrically determined moment arm vectors to determine the resulting moment.

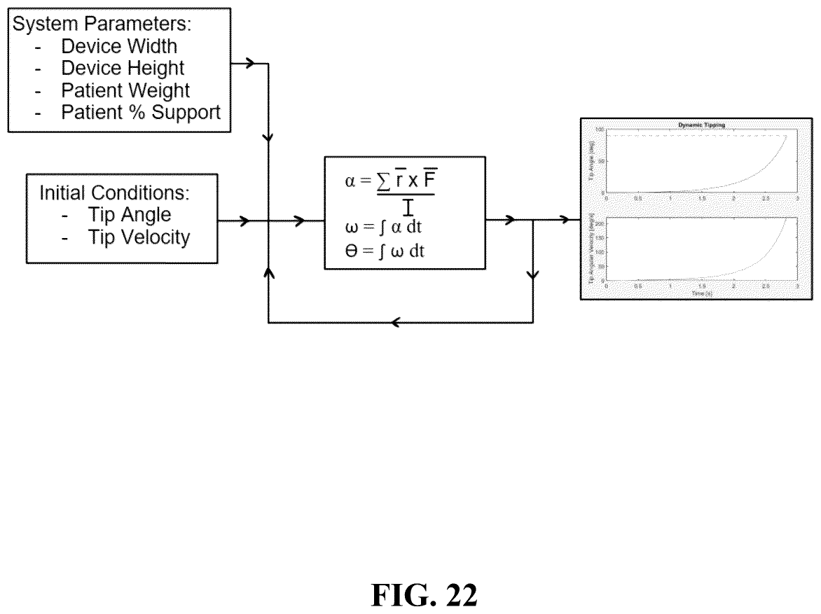

FIG. 22 is a flow representation of the dynamic tipping simulation. The program's key inputs are initial conditions and system parameters, the primary functions are calculating angular acceleration from these inputs and numerically integrating to find angular velocity and position, and the output is a pair of graphs of angular position vs. time and angular velocity vs. time. The output graph can be used to determine for how long a given load must be applied for system 100 to tip. By using this simulator, an estimation of system response to impulse loading can be determined.

The key takeaway from the dynamic simulation is that system 100 is vulnerable to high impulse loading when system 100's width is small enough to fit through a narrow doorway. To satisfy both requirements of safety and maneuverability, a hinge mechanism 128 was added at the top of system 100 to adjust system width and, correspondingly, stability. This hinge 128 allowed system 100 to collapse to a more vulnerable state in order to fit through doorways and expand to a more stable state when space is unrestricted. This compromise maintains system functionality while providing extra stability when possible.

### Bungee Selection and Characterization

The bungees were chosen as the same ones as a PUMA system as smaller diameter bungees tested become inelastic before providing full body weight support. This is an undesirable response because system 100 needs to constantly provide an amount of upward force at a variety of elevations in order to provide continuous partial to full body weight support despite the natural rise and fall of walking.

In order to prove their effectiveness and characterize how much they deflect in response to a given load, force vs displacement data was gathered for various lengths using a ruler, a hook, two CAM clips to hold the bungees firmly in place, and a force gauge. The bungees were characterized empirically for accuracy due to the unknown polymer material and complex mechanisms inherent with composite systems.

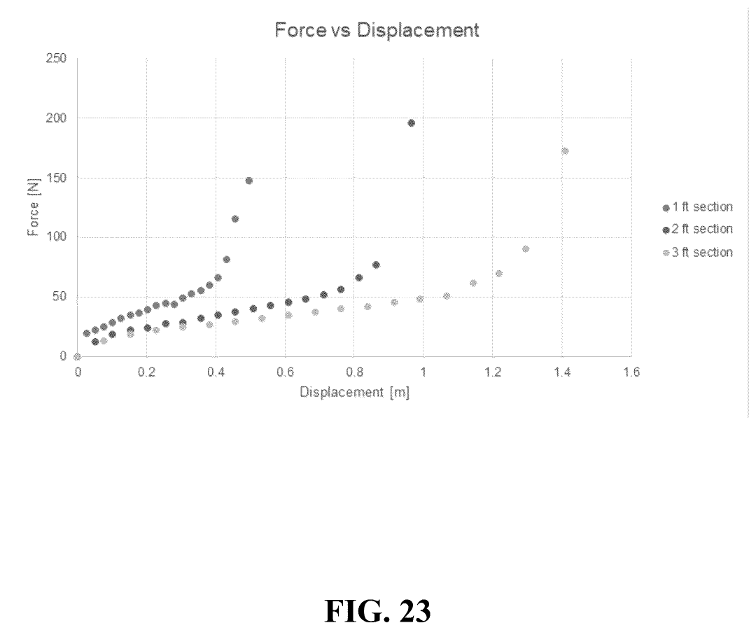

Because the force vs displacement graph shown in FIG. 23 and the stress vs strain graphs failed to parameterize the data effectively across all potential lengths, the Fixed-Junction Model of Polymer Elasticity was used to characterize their response more accurately to a given inputted force. The governing equation for this model is included below:

$$σ = G ( {λ}^{2} - \frac{1}{λ} ) where stretch is λ = \frac{L}{{L}_{0}} \qquad Equation 2$$

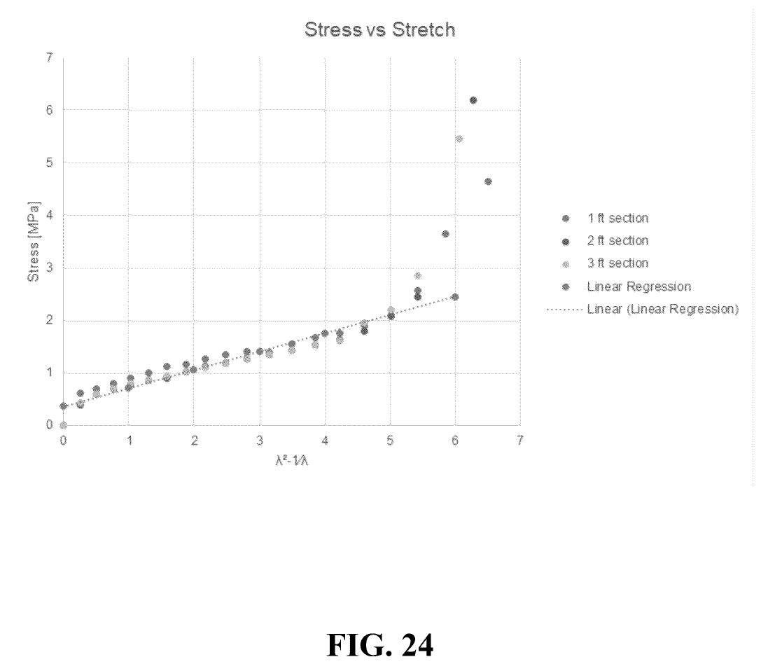

FIG. 24 plots the linearized stress vs stretch data such that the shear modulus, G, can be determined via linear regression.

A linear regression of the data within the elastic region yielded a shear modulus value of 0.349 MPa.

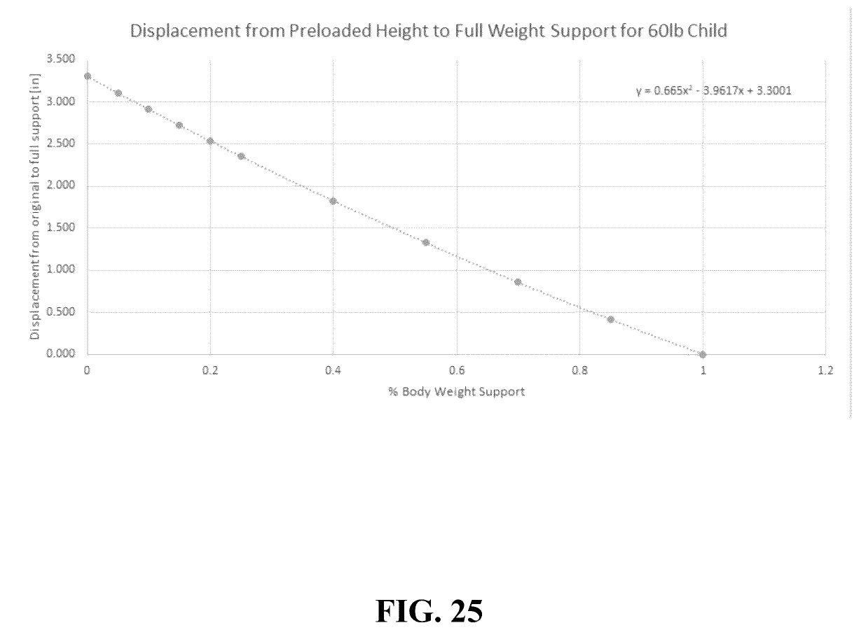

Finally, using the derived relationship below, the amount of displacement for a given weight and preload from body weight support was determined and graphed in FIG. 25.

$$F = GA [ {( \frac{L}{{L}_{0}} )}^{2} - ( \frac{{L}_{0}}{L} ) ] \qquad Equation 3$$

In other words, this equation and subsequent graph is used to determine how far a child weighing 60 pounds falls if they tripped given the amount of body weight support the bungees provided. For instance, if the 60-pound child was initially given no body weight support, or the bungees were not preloaded, if they tripped or otherwise stopped supporting their body weight, they fall less than 3.5″ before the bungees fully support them. This means that even if the patient trips, they will not fall.

### Bungee Connection Hardware

On the PUMA, quick disconnect carabiners were used to connect the bungees to the harness. These carabiners can be removed quickly, but fall apart if too much force was used, and required two hands to connect, as observed during a patient's therapy session.

To simplify use of the gait trainer, the design team decided to pick Frog Carabiners. These carabiners are designed and patented by KONG and can be operated with one hand for attaching and detaching. Additionally, the carabiner does not fall apart when used with force.

### Frame Pickups for Steering Bungees

The steering pickups connect the user to frame 104 at the hips, allowing the user to steer the gait trainer. Using the same nylon webbing that will be used to add additional pickup points on the harness, a multi-loop strap will be created via riveting the webbing to frame 104. Exemplary frame pickup design can be seen in FIG. 26.

### Casters

The caster wheels 136 are a key element to providing mobility to system 100, providing functional solutions to the requirement to be able to move freely within a residential setting and also remain operable by the patient. To freely move within a residential setting, a caster wheel 136 must easily overcome obstacles, such as a ¾″ flooring transition, and also move in an omnidirectional manner. The caster wheels 136 must roll over a variety of different surface materials with a rolling resistance under the 8 lbf lateral force the patient can generate in order for it to be operable independently. Finally, for safety, the casters 136 must be lockable to prevent unintended movement of system 100 and also support the weight of frame 104 and the patient with a safety factor.

The important criteria to consider when selecting the caster wheel 136 to meet the needs of system 100 are locking functionality, swivel functionality, wheel material, weight capacity, and the wheel radii. Because the wheel needs to move in an omnidirectional manner, it was determined that the caster wheel 136 must have a swivel rather than being fixed. In order to overcome a ¾″ floor transition easily, Team UTME Support calculated that a wheel size of 5″ was most optimized for a balance between ease of movement over the flooring transition and the turning radius, which is dependent on the swivel radius. To determine the locking functionality, the following table compares the different locking functionality.

Due to the critical constraint of ease of acquiring, the lever locking total brake mechanism is preferred despite the inability to independently lock the caster's swivel while allowing wheel rotation. This is because the time and cost constraint is an engineering specification and the ability to aid directional movement is not.

Due to the simplicity of mounting, its availability across a wide range of casters, the ease of adjustability, and minimal additional mounting components required, the best mounting option was determined to be the threaded stem.

Because the residential environment frame 104 is to be used in has both low-pile carpet, ceramic tiles, and wood flooring, the caster wheel's material must be able to easily traverse all of the flooring options so that system 100 is independently operable by the patient's strength. The caster wheel 136 material was selected as Polyolefin because it is hard enough to be able to tread carpet while also being soft enough to effectively traverse hard flooring like tile without damaging it. Based on the engineering requirements, the maximum weight of frame 104 with a fully supported child is 110 lbs, and thus the weight capacity of each caster wheel 136 must be at a minimum of 165 lbs after inclusion of the safety factor based on a worst-case loading scenario where only two wheels have contact with the ground.

As a compilation of these decisions, the best caster was decided to be the 5″ Polyolefin Total Lock Stem Model from Caster City, as included in the BOM. The TS26N option was chosen despite the additional cost because it made the threaded stem longer and thus improve both adjustability and stability. This option is also a thicker stem diameter which makes the stem more robust.

### Harness Modifications

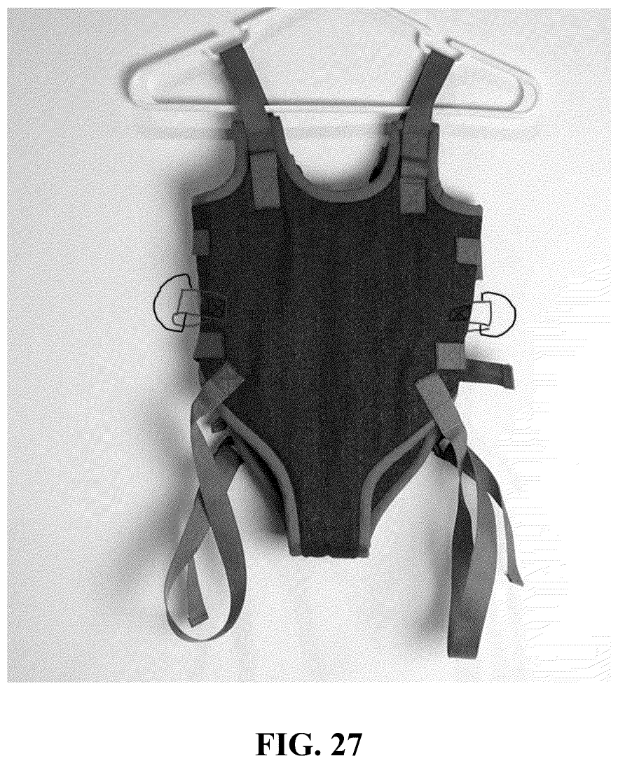

The harness modification materials were chosen as the most similar options to the current PUMA harness that added two new pickups to the harness in the front. The nylon webbing and thread were chosen for strength, durability, and their ability to be sewn using the Sailrite machine available to the design team at the EER Invention Works. The D rings were then chosen as the cheapest option that fits the nylon webbing chosen. This pattern is the same that is used on the PUMA straps. This pattern was justified by Ralph Cope because it is the same thread pattern used on seat belts and other safety critical hardware. An exemplary harness is shown in FIG. 27.

### Frame Shielding

Frame shielding is necessary to prevent injury such as contusions to the user or damage to the environment from the impacts with protruding hardware and exposed frame edges by reducing the impact stresses through the use of a buffering material that can elastically deform. The length of material needed was determined from the SolidWorks CAD model of frame 104, which led to a maximum of 45″ per leg if using a tubing-based solution, or 180″ per leg if using corner protector strips. The solution must have an internal dimension of 2.25″ to properly cover the protruding hardware and have enough thickness to provide padding. For all the other edges, the padding shall also cover each face of frame 104 tubing, which is 1.5″ per side.

Consisting of three foam tubing sections secured with Velcro straps that reach a height of 53 inches tall, the lower leg and upper leg sections remain on the frame tubes during normal assembly and disassembly, with only the middle leg section removable to provide access to the assembly hardware. This change reduces the number of straps from 5 to 2 and steps needed for assembly and disassembly per leg, cutting a significant amount of time and complication in assembly. A cut-out of the lower leg section over the hip-strap attachment area allows easy accessibility for adjustment while still covering frame 104's edges.

Because of the difficulty of quantifying a standard amount of stress required to bruise, cut, or abrade the skin, the protective quality of the foam padding was measured based on the compressive strength at different levels of compression. To avoid direct contact with frame 104, the compression of the padding shall never reach 100% strain. The weight of the foam tubing of 5 ounces was used to calculate the density, which resulted in a 1.30 lb/cubic foot. Assuming that most low-density polyethylene foam has similar properties for a foam with a density of 1.2 lb/cubic foot to estimate the lower bound of mechanical properties of the selected foam. Based on these findings, the user must exert more pressure than 12 psi in order to compress the foam shielding to 100% strain.

### Wheel Shielding

Due to the geometry of frame 104, parts of the caster wheel infringe on the bounding box during certain modes of operation and can cause unintended injury via the rolling over or pinching of the user's appendages. The wheel shielding device prevents such injuries by covering possible pinch points and providing a physical barrier to the wheel.

One design alternative was to use a flexible plastic training cone to provide a deflecting angle for the appendages and also cover parts of the wheel from pinching. Because of a lack of mounting options on the caster wheel 136, this design used strong adhesive to directly attach to the sheet metal fork of the caster wheel 136. This design was rejected due to the permanence of the mounting solution and also the large footprint of the solution, which both increases the footprint of frame 104 and infringes more upon the bounding box.

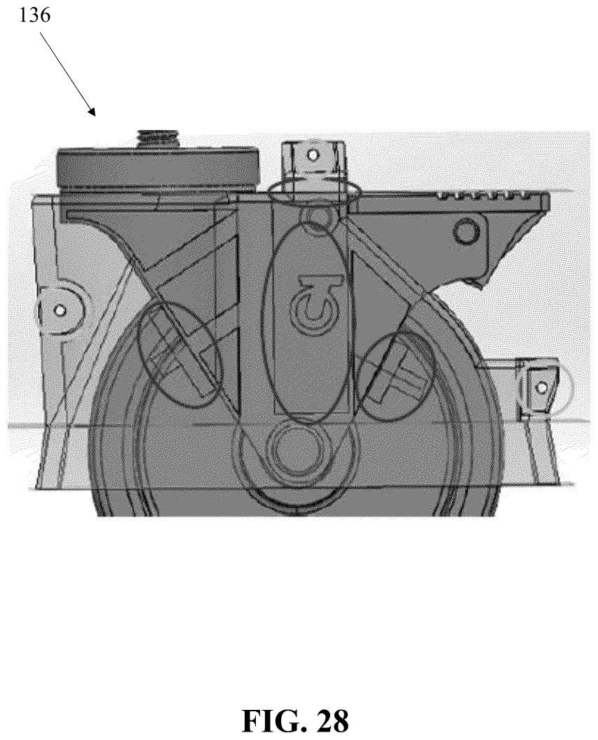

The wheel shielding device accomplishes its two functions of covering possible pinch points and providing a physical barrier to the wheel via two components: the mounted bracket and attached skirt. The bracket is 3D-printed in a complex geometry to follow the contours of the caster wheel 136, using faces on the front, back, top, and sides to locate and affix the bracket as shown in FIG. 28 as circled in red. It is printed in two halves to allow for easy assembly and disassembly, and the halves are secured together using three 6-32 nuts and bolts, which are located at the holes circled in FIG. 28.

The disclosures of each and every patent, patent application, and publication cited herein are hereby incorporated herein by reference in their entirety. While this invention has been disclosed with reference to specific embodiments, it is apparent that other embodiments and variations of this invention may be devised by others skilled in the art without departing from the true spirit and scope of the invention.

What is claimed is:

1. A system for gait training comprising:
a frame comprising a first, second, third and fourth leg;
a pivoting bar rotatably coupled to an upper portion of the frame and configured to rotate independent of the frame; and
a plurality of flexible support members connected to the frame, the plurality of flexible support members comprising at least one upright flexible support member connected to the pivoting bar and at least one lateral flexible support member connected to at least one of the first, second, third and fourth legs.

2. The system of claim 1, wherein the at least one upright flexible support member is one of a plurality of upright flexible support members connected to the pivoting bar.

3. The system of claim 1, wherein the at least one lateral flexible support member is a first lateral flexible support member connected to the first leg, and wherein a second lateral flexible support member is connected to the second leg, a third lateral flexible support member is connected to the third leg, and a fourth lateral flexible support member is connected to the fourth leg.

4. The system of claim 3, wherein first, second, third and fourth lateral flexible support members are elastic.

5. The system of claim 3, wherein the first, second, third and fourth lateral flexible support members are bungee straps.

6. The system of claim 3, wherein the first, second, third and fourth lateral flexible support members are connected to a user harness.

7. The system of claim 6, wherein the first, second, third and fourth lateral flexible support members are configured to the user harness at waist level and configured to provide steering support.

8. The system of claim 2, wherein the plurality of upright flexible support members are connected to a user harness.

9. The system of claim 8, wherein the plurality of upright flexible support members are configured to provide omnidirectional support to a user.

10. The system of claim 1, wherein the at least one upright flexible support member is adjustable in at least one of length, direction or magnitude of force applied.

11. The system of claim 1, wherein each leg comprises a caster mounted to a bottom portion.

12. The system of claim 1, wherein the frame is configured to permit adjustment of width between adjacent legs while in use.

13. The system of claim 1, wherein the frame is configured to bias towards an unadjusted state while in an adjusted state.

14. The system of claim 1, wherein the frame is configured to increasingly bias towards an unadjusted state when moving increasingly into an adjusted state.

15. The system of claim 1, wherein the frame comprises an upper arch comprising the first and third leg, and a lower arch comprising the second and fourth leg.

16. The system of claim 15 wherein the upper arch and lower arch each comprise an opening that aligns for accepting insertion of a connection element that couples the upper arch and lower arch along a central axis.

17. The system of claim 16 further comprising:
a hinge having a shaft fixed within the lower arch of the frame, wherein the shaft comprises a mounting point along the central axis for the pivoting bar.

18. The system of claim 16, wherein the hinge further comprises a hinge lock.

19. The system of claim 18, wherein the hinge lock comprises of at least three linkages each connecting to different legs.

20. The system of claim 16, wherein the frame is configured with a protrusion to block adjacent leg angles less than a predetermined number of degrees.
